(19) United States
(12) Patent Application Publication
(10) Pub. No.: US 2009/0308303 A1
(43) Pub. Date: Dec. 17, 2009

(54) Identification marker

(76) Inventor: Albert A. Burlando, Flanders, NJ (US)

Correspondence Address: DAY PITNEY LLP, 7 TIMES SQUARE, NEW YORK, NY, 10036-7311, US

(21) Appl. No.: 12/157,941

(22) Filed: Jun. 13, 2008

(51) Int. Cl. G01D 21/00

(52) U.S. Cl. 116/209

(57) ABSTRACT

A cable marker includes a flag for connection to a support stake, wherein the flag has a center portion for connection to the support stake and includes a first side portion having an exterior display surface for an identification sign and a second side portion having an exterior display surface for an identification sign. By using a first side portion having an exterior display surface with an identification sign and a second side portion having an exterior display surface with an identification sign, the problem of not knowing the type of underground line being identified by the marker is avoided.

### BACKGROUND OF THE INVENTION

1. Field of the Invention

This invention relates to an identification marker, and, more particularly, this invention relates to an identification marker, for a subterranean electrical cable or other conduit, having a display surface capable of receiving information.

2. Description of the Prior Art

Cable markers of the prior art include color-coded strands, commonly known as “whiskers”, and wooden support stakes to which the strands are nailed or otherwise attached, preferably in a vertical orientation. One problem with these cable markers is that it is difficult to know the type of underground line being identified, particularly when the color code of the strands is not known.

### OBJECTS AND SUMMARY OF THE INVENTION

An object of the present invention is to provide an improved underground cable identification system.

Another object of the present invention is to provide an improved underground cable identification system capable of withstanding external forces.

Still another object of the present invention is to provide an improved underground cable identification system of improved visual recognition.

Yet another object of the present invention is to provide an improved underground cable identification system capable of easy installation.

These and other objects of the present invention are achieved by a cable marker comprising a flag for connection to a support stake, wherein the flag has a center portion for connection to the support stake and includes a first side portion having a display surface for an identification sign and a second side portion having a display surface for an identification sign. By using a first side portion having a display surface with an identification sign and a second side portion having a display surface with an identification sign, the problem of not knowing the type of underground line being identified by the marker is avoided.

### BRIEF DESCRIPTION OF THE DRAWINGS

A better understanding of the present invention as well as other advantages thereof will be achieved upon consideration of the detailed disclosure thereof, especially when taken with the accompanying drawings, wherein like numerals indicate like parts throughout and wherein:

FIG. 1 is a perspective view of an identification marker according to the invention;

FIG. 2 is an enlarged view of a portion of FIG. 1;

FIG. 3 is a developed view of a portion of FIG. 1;

FIG. 4 is an elevational view of a portion of FIG. 1;

FIG. 5 is a sectional view as taken along the line 5-5 of FIG. 4;

FIG. 6 is a second embodiment of an identification marker according to the invention;

FIG. 7 is a third embodiment of an identification marker according to the invention;

FIG. 8 is a sectional view as taken along the line 8-8 of FIG. 7; and

FIG. 9 is a fourth embodiment of an identification marker.

### DETAILED DESCRIPTION OF THE PREFERRED EMBODIMENTS

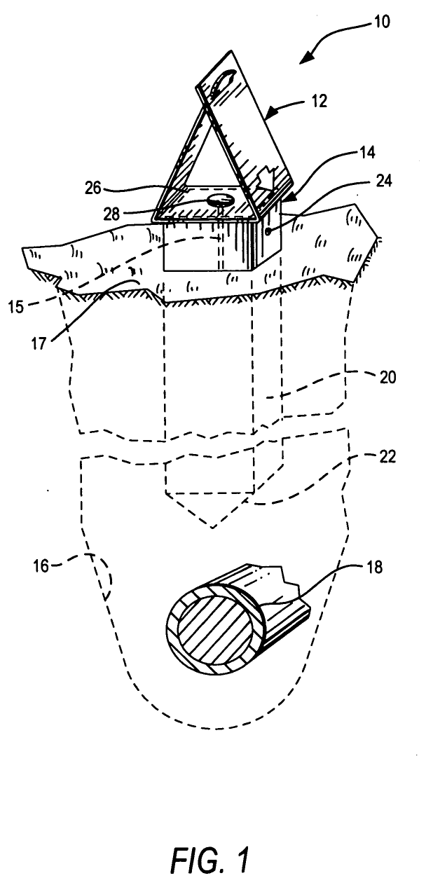

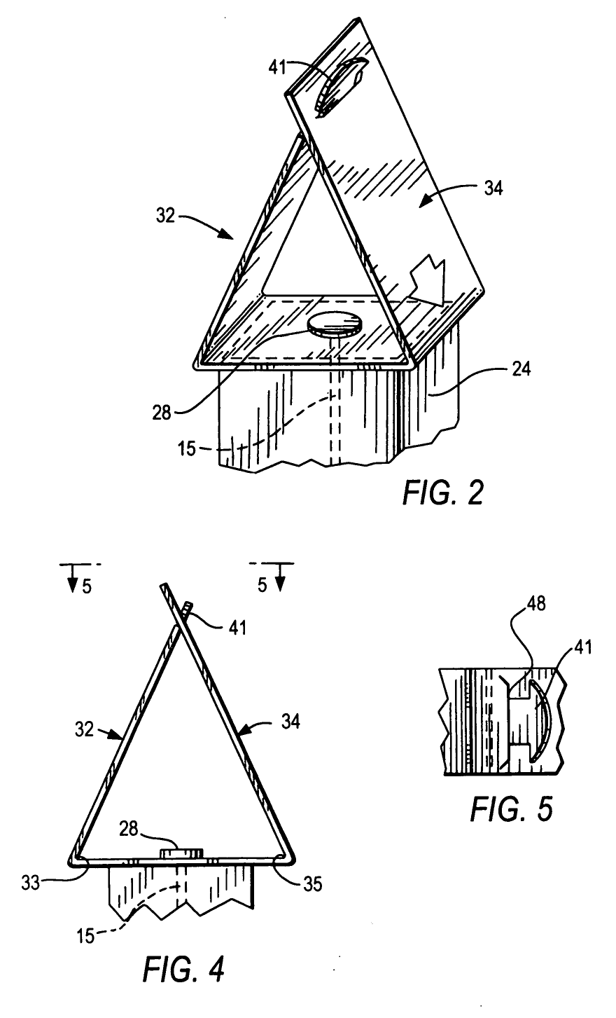

Referring to these figures, FIGS. 1 and 2 illustrate a marker, generally indicated as 10, including a flag 12 and a wooden support stake 14 to which the flag 12 is attached by a nail 15. The marker 10 is supported in the ground 17, which is disposed in a backfilled trench 16. The marker 10 identifies an electrical cable 18, which is disposed in the backfilled trench 16. The stake 14 includes a center portion 20, a lower end portion 22, and an upper and portion 24, having a flat end surface 26. The nail 15 has an enlarged head portion 28.

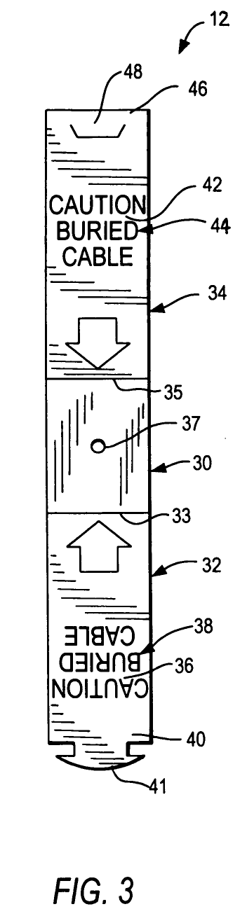

In FIG. 3, which is a developed view, the flag 12 is shown formed of a center portion 30, a first or left side portion 32, having score line 33, and a second or right side portion 34, having score line 35. The center portion 30 is provided with a hole 37 for the nail 15. First side 32 includes an exterior display surface 36 for an identification sign 38 and a tab portion 40, having an arrowhead-shaped projecting tab 41. The second side 34 includes an exterior display surface 42 for an identification sign 44 and a slotted portion 46, including an arcuate slot 48 for receiving the tab 41.

In FIG. 4, the sides 32 and 34 are shown folded along the respective score lines 33 and 35.

In FIG. 5, the tab 41 is shown received or inserted in the slot 48. The flat end surface 26 of the stake 14 is preferably disposed close to the ground 17 so that, if the marker 10 is run over, the stake 14 will not be bent over, and so that the flag 12, of a flexible material such as plastic, will return to an upright position. Moreover, flag 12 may be color-coded to indicate the type of cable or conduit it is being used to identify in addition to the identification signs 38, 44.

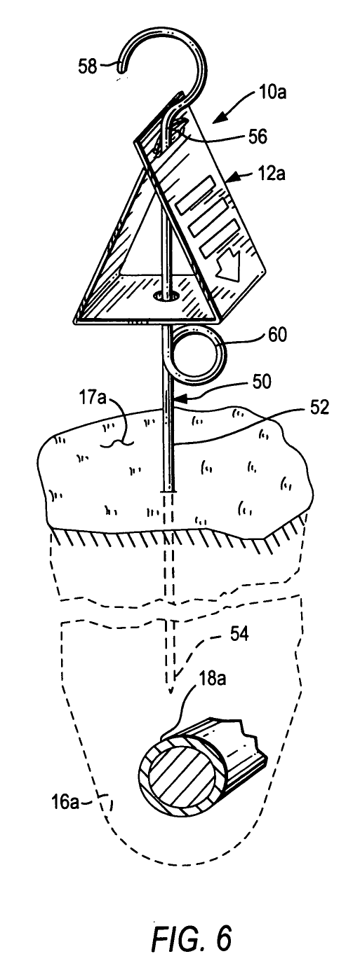

FIG. 6 shows a second embodiment of the present invention, marker 10a, having parts similar to the parts of marker 10 in FIG. 1, and having the same drawing reference numerals, but with a subscript “a” added thereto. The marker 10a includes a flag 12a and a wire rod stake 50, supporting the flag 12a. The marker 10a is supported by the ground 17a, disposed in a backfilled trench 16a having a cable 18a buried therein. The stake 50 includes a center portion 52, a lower end portion 54, and an upper end portion 56. The upper end portion 56 is formed with a hook portion 58. The center portion 52 includes a loop 60, supporting flag 12a in a vertical direction, as required.

The flag 12a is identical in construction to the flag 12. It is noted that, as an alternative not shown in FIG. 6, two flags 12a can be stacked, one above the other, upon and supported by wire rod stake 50, where one is disposed at a 90° angle in plan view from the other to provide a four-way view. The stake 50 is preferably made of a bendable metal, so that, if marker 10a is run over, both flag 12a and stake 50 will return to an upright position. The marker 10a is preferably used in ground 17a of a consistency and content permitting the forcing of the wire rod stake 50 in a vertical direction into the ground 17a without bending.

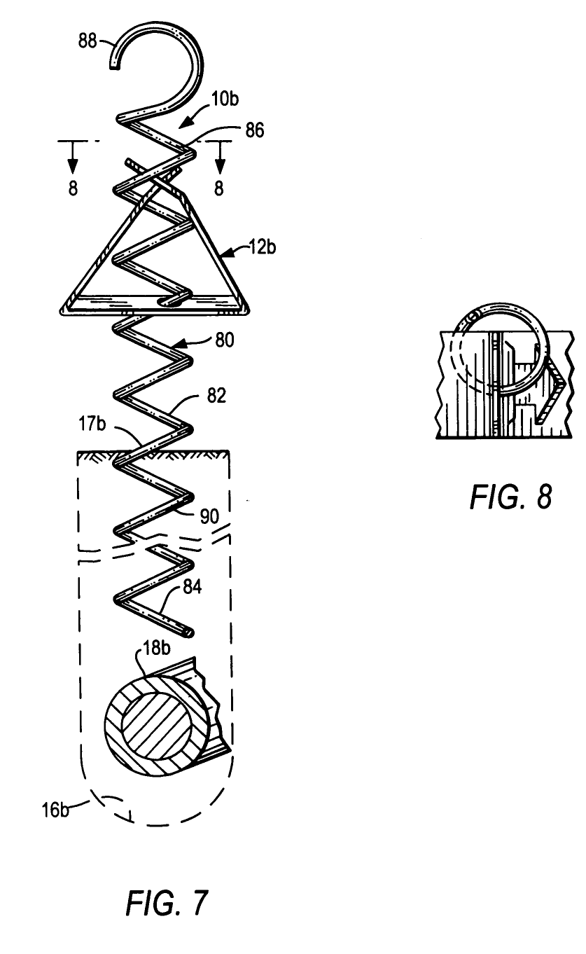

FIGS. 7 and 8 show a third embodiment of the present invention, marker 10b, having parts similar to the parts of marker 10 in FIG. 1, and having the same drawing reference numerals, but with a subscript “b” added thereto. The marker 10b includes a flag 12b and a wire coil stake 80 supporting the flag 12b. The marker 10b is supported by ground 17b disposed in a backfilled trench 16b having a cable 18b buried therein. The stake 80 includes a center portion 82, a lower end portion 84, and an upper end portion 86. The upper end 86 includes a hook portion 88. The center portion 82 and the lower end portion 84 have a plurality of coils 90. The hook portion 88 can be turned by hand in order to screw the marker 10b into the ground 17b when the ground 17b is of a suitable consistency and content.

The flag 12b is identical in construction to the flag 12. It is noted that, as an alternative not shown in FIGS. 7 and 8, two flags 12b can be stacked, one above the other, upon and supported by wire coil stake 80, where one is disposed at a 90° angle in plan view from the other to provide a four-way view.

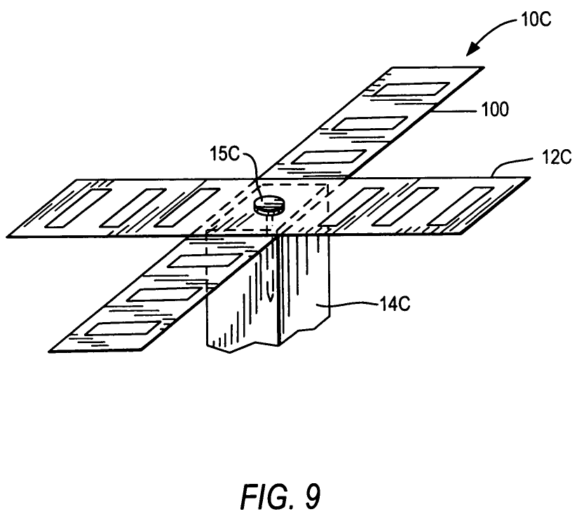

FIG. 9 shows a fourth embodiment of the present invention, marker 10c, including a first flag 12c, a second flag 100 and a wooden support stake 14c. The flags 12c and 100 are connected to the stake 14c by a nail 15c and are identical in construction to the flag 12 of marker 10 of FIG. 1. The marker 10c provides a four-way view for four-direction identification when flags 12c and 100 are folded as shown for flags 12, 12a, 12b in FIGS. 1, 6, and 7.

Advantages of the markers 10, 10a, 10b, 10c of the present invention are:

a. By using a first side portion 32, having an exterior display surface 36 with an identification sign 38, and by using a second side portion 34, having an exterior display surface 42 with an identification sign 44, the prior-art problem of not knowing the type of underground line being identified by the marker is avoided.

b. The marker 10 is flexible in the sense that it can be run over and will return to an upright position.

c. The marker 10a can use two or more units of flag 12a for multi-view identification.

d. The marker 10a can be inserted into ground 17a by hand when the content of ground 17a is suitable for this purpose.

e. The marker 10b can be inserted into ground 17b by hand by turning hook 88 while applying force in a downward direction.

f. The marker 10c provides a multi-view wooden support stake 14c.

While the present invention has been illustrated in a plurality of embodiments, it is to be understood by one skilled in the art that the present invention may be used in other embodiments. It will be understood that many modifications will be apparent to those of ordinary skill in the art and that the application is intended to cover any adaptations or variations thereof. Therefore, it is manifestly intended that this invention be only limited by the claims to follow and the equivalents thereof.

What is claimed is:

1. A cable identification marker for locating and identifying an elongated subterranean cable or other conduit disposed below ground in a backfilled trench, said marker comprising:
a flag for connection to a support stake,
said flag having a center portion for connection to the support stake and having a first side portion having a display surface for an identification sign and having a second side portion.

2. The marker of claim 1, wherein the second side portion has a display surface for an identification sign.

3. The marker of claim 1, wherein the flag is composed of a flexible plastic material.

4. The marker of claim 1, wherein the first side portion has a tab portion having a tab, and wherein the second side portion has a slot portion with a slot which receives the tab.

5. The marker of claim 4, wherein the tab has an arrowhead shape, and wherein the slot has an arcuate shape for locking the tab in place.

6. The marker of claim 1, wherein said stake is a wooden support stake, and wherein the flag center portion has a hole, and wherein the hole receives a nail which is embedded in said wooden support stake.

7. The marker of claim 1, wherein the stake is a wire rod stake having a loop portion, for supporting the flag.

8. The marker of claim 1, wherein the stake is a wire coil stake for ease of insertion in the ground.

9. The marker of claim 1, wherein a second flag is mounted on the stake, the second flag being identical to the first flag and being disposed at 90° approximately thereto in plan view.
